(19) United States
(12) Patent Application Publication
(10) Pub. No.: US 2009/0320628 A1
(43) Pub. Date: Dec. 31, 2009

(54) SLIDING MECHANISM

(75) Inventor: CHIH-CHIEN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/401,722

(22) Filed: Mar. 11, 2009

(30) Foreign Application Priority Data
Jun. 26, 2008 (CN) 200810302342.3

(51) Int. Cl. F16F 1/18

(52) U.S. Cl. 74/100.2

(57) ABSTRACT

A sliding mechanism for a portable electronic device includes a body section, a cover section, a coil spring mounted to the body section, and an elastic sheet fixed to the cover section. The body section or the cover section defines a sliding slot on a side thereof, with the other section comprising a rail corresponding to the sliding slot. The rail is slidably received in the sliding slot. The coil spring deforms the elastic sheet to generate tensile force when the coil spring is not aligned with the elastic sheet, driving the cover section to the open or closed position.

### BACKGROUND

1. Field of the Invention

The present invention relates to device housings and, particularly, to a sliding mechanism used in a portable electronic device.

2. Description of Related Art

Portable electronic devices with sliding housings often include a main housing, a slidable housing, and a sliding mechanism. The sliding mechanism slides the slidable housing with respect to the main housing.

The sliding mechanism usually includes a body section, a cover section and a torsion spring. One end of the torsion spring is fixed to the body section, and the other end of the torsion spring is fixed to the cover section. The cover section can slide relative to the body section by release of elastic force of the torsion spring. Thus, when the main housing and the slidable housing are respectively fixed to the body section and the cover section, the slidable housing can slide relative to the main housing.

However, the torsion spring typically has a limited distortion potential. After repeated use, the torsion spring may fail to function properly and degrade function of the sliding mechanism.

Therefore, there is room for improvement within the art.

### BRIEF DESCRIPTION OF THE DRAWINGS

Many aspects of the sliding mechanism can be better understood with reference to the following drawings. These drawings are not necessarily drawn to scale, the emphasis instead being placed upon clearly illustrating the principles of the present sliding mechanism. Moreover, in the drawings like reference numerals designate corresponding sections throughout the several views.

FIG. 1 is an exploded, isometric view of a sliding mechanism, in accordance with an exemplary embodiment.

FIG. 2 is an enlarged, isometric view of the cover section shown in FIG. 1.

FIG. 3 is an isometric, assembled view of the sliding mechanism shown in FIG. 1.

FIG. 4 is a top view of the sliding mechanism shown in FIG. 3 in a closed position, corresponding to an opening/closing operation of the sliding mechanism.

FIG. 5 is a top view of the sliding mechanism shown in FIG. 3 in an intermediate position, corresponding to an opening/closing operation of the sliding mechanism.

FIG. 6 is a top view of the sliding mechanism shown in FIG. 3 in an open position, corresponding to an opening/closing operation of the sliding mechanism.

### DETAILED DESCRIPTION OF EXEMPLARY EMBODIMENT

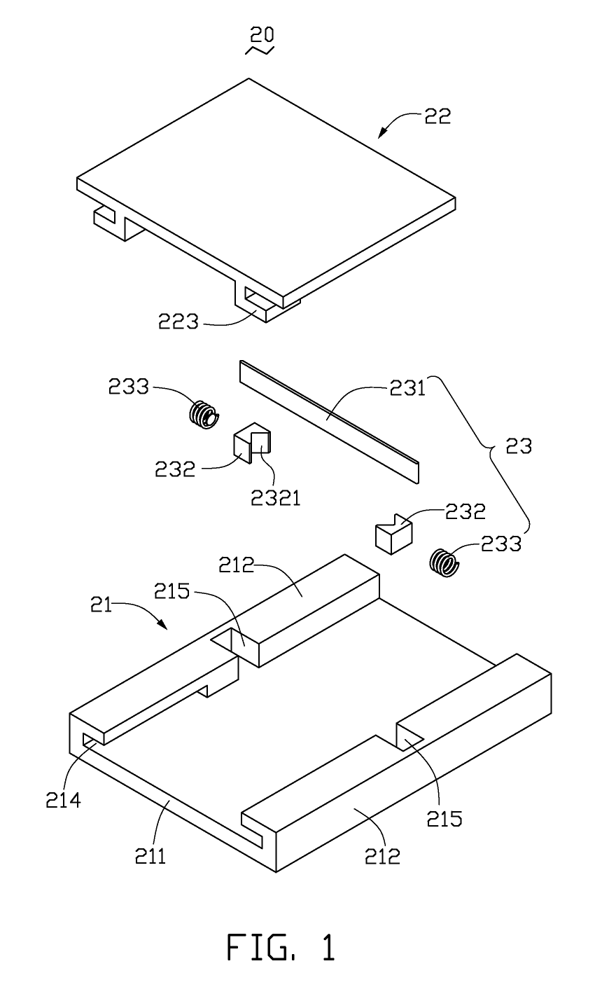

FIG. 1 shows an exemplary sliding mechanism 20 for portable electronic devices such as mobile phone terminals, digital cameras and others. The sliding mechanism 20 includes a body section 21, a cover section 22, and a driving mechanism 23. The cover section 22 is slidably mounted to the body section 21 by the driving mechanism 23.

The body section 21 is generally rectangular, including a base 211 and two bars 212. The two bars 212 are symmetrically arranged on opposite sides of the base 211 along a longitudinal orientation. Each bar 212 has a sliding slot 214 defined between the bars 212 and the base 211, and a receiving cavity 215 defined at the center. The receiving cavities 215 face each other. The sliding slots 214 are adjacent to the receiving cavities 215 along the bars 212.

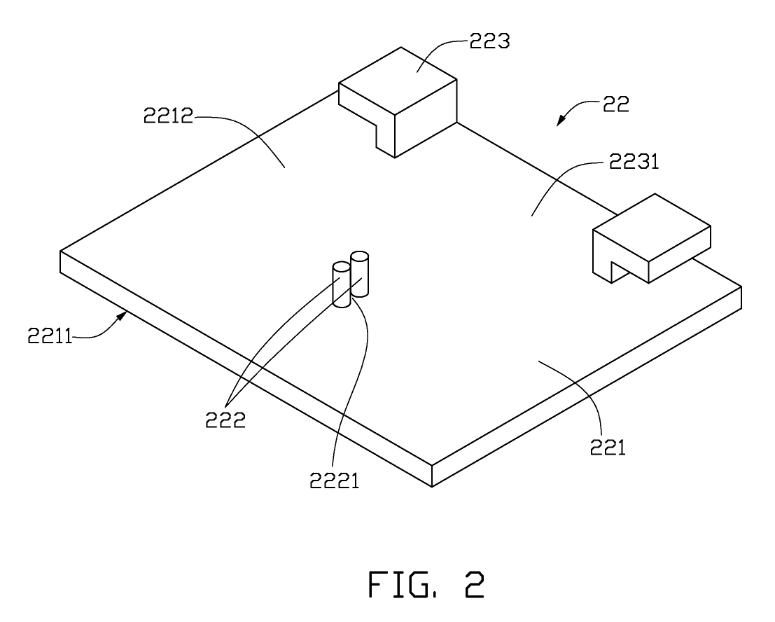

Referring to FIG. 2, the cover section 22 includes a plate 221, two securing columns 222, and two rails 223. The plate 221 includes a top surface 2211 and a bottom surface 2212 opposite to the top surface 2211. The securing columns 222 protrude from a center of the bottom surface 2212 close to each other, defining a securing space 2221 therebetween. Each rail 223 is generally L-shaped and configured to slidably engage the sliding slots 214. The two rails 223 protrude from two opposite ends of the bottom surface 2212, defining a gap 2231 therebetween. The rails 223 horizontally align with each other.

Referring to FIG. 1, the driving mechanism 23 includes an elastic sheet 231, two retaining blocks 232 and two coil springs 233. The elastic sheet 231 is thin and, when bent, generates an elastic force. Each retaining block 232 defines a V-shaped groove 2321 receiving an end of the elastic sheet 231.

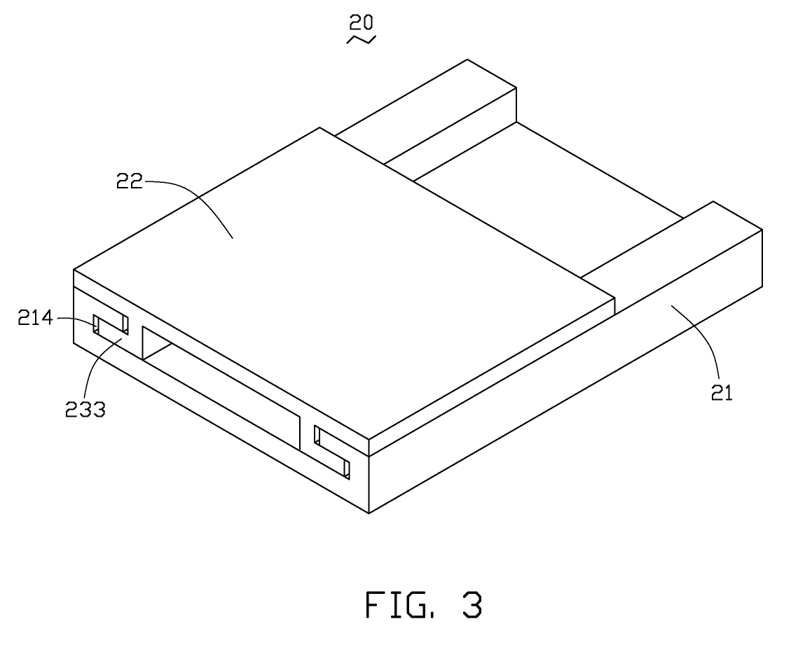

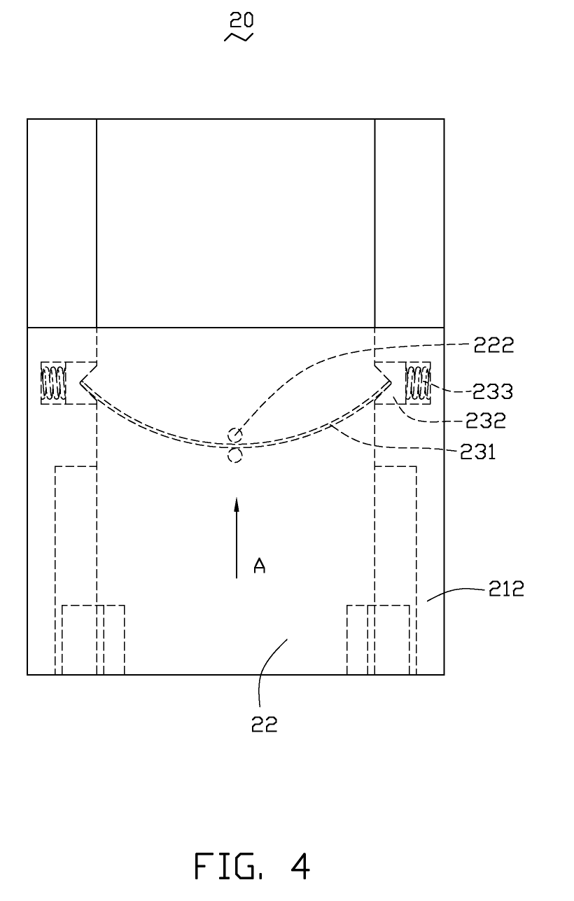

Referring to FIG. 3, during assembly of the sliding mechanism 20, the coil springs 233 are respectively received in the receiving cavities 215. Retaining blocks 232 are respectively inserted into the receiving cavities 215 with the grooves 2321 facing each other. One end of the coil spring 233 abuts the bar 212, and the other end of the coil spring 233 abuts the retaining block 232. The elastic sheet 231 is inserted into the securing space 2221 of the cover section 22. The cover section 22 and the elastic sheet 231 align with and are mounted to the body section 21 by engaging the rails 223 into the sliding slots 214. At this stage, the elastic sheet 231 is held in the grooves 2321 of the two retaining blocks 232. The two coil springs 233 are compressed to generate tensile force, deforming the elastic sheet 231 until the elastic force thereof equals the tensile force. At this time, the cover section 22 is in a closed position (see FIG. 4).

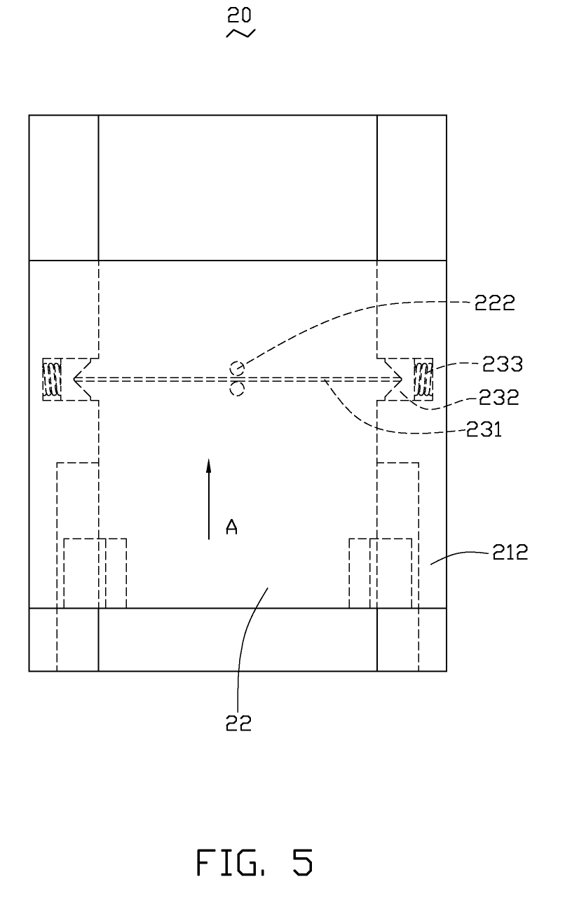

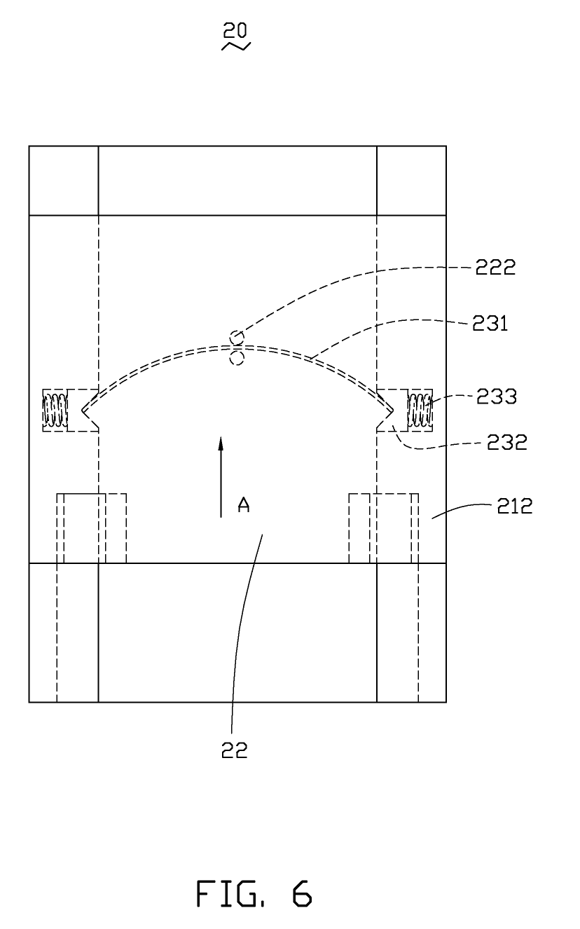

FIGS. 4 through 6 show the cover section 22 moving from closed to open position. The cover section 22 may be slid along an arrow A from the closed position (FIG. 4) until the cover section 22 reaches an intermediate position (FIG. 5). In the intermediate position, the elastic sheet 231 is straight, compressing and aligning with the axes of the coil springs 233. When the cover section 22 is further impelled past the intermediate position, the coil springs 233 return to deform the elastic sheet 231 along the axis of the sliding slot 214. Accordingly, the cover section 22 opens as shown in FIG. 6 along the sliding slot 214. Thus, by tensile force of the elastic sheet 231, the cover section 22 automatically slides to the open position. The above process can be reversed and the cover section 22 slides back from the open position to the closed position.

In alternative embodiments, the retaining blocks 232 can be omitted, and the coil springs 233 directly deform the elastic sheet 231.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A sliding mechanism, comprising:
a body section;
a cover section;
a coil spring mounted to the body section; and
an elastic sheet fixed to the cover section;
wherein the body section or the cover section defines a sliding slot on a side thereof, with the other section comprising a rail corresponding to the sliding slot, the rail being slidably engaged in the sliding slot, and the coil spring deforms the elastic sheet to generate tensile force when the coil spring is not aligned with the elastic sheet, driving the cover section to an open or closed position.

2. The sliding mechanism as claimed in claim 1, wherein the body section or the cover section defines another sliding slot on its other side, and the other section comprises another rail corresponding to the other sliding slot, with the other rail slidably engaged in the other sliding slot.

3. The sliding mechanism as claimed in claim 2, wherein the cover section includes a plate and two securing columns, the plate including a top surface and a bottom surface, from a center of which the securing columns closely protrude, forming a securing space therebetween fixing the elastic sheet.

4. The sliding mechanism as claimed in claim 3, wherein the two rails symmetrically protrude from one edge of the bottom surface, forming a gap therebetween, with which the two securing columns align.

5. The sliding mechanism as claimed in claim 2, wherein the body section includes a base and two bars symmetrically arranged on opposite sides thereof along a longitudinal orientation, from each inside surface of which the sliding slot is outwardly defined.

6. The sliding mechanism as claimed in claim 5, wherein the inside surface of each bar further defines a receiving cavity at a center thereof, receiving the coil spring therein.

7. The sliding mechanism as claimed in claim 6, wherein the sliding mechanism further includes two retaining blocks, each defining a V-shaped groove receiving one end of the elastic sheet, wherein the retaining blocks are respectively received in the receiving cavity with one end of the coil spring abutting a corresponding bar and the other end of the coil spring abutting corresponding retaining blocks.

8. A sliding mechanism, comprising:
a body section;
a cover section;
an elastic sheet fixed to the cover section; and
a coil spring mounted to the body section, the coil spring being used to deform the elastic sheet to generate tensile force, driving the cover section to slide relative to the body section.

9. The sliding mechanism as claimed in claim 8, further comprising a retaining block, wherein the retaining block is slidably mounted to the body section and disposed between the coil spring and one end of the elastic sheet.

10. The sliding mechanism as claimed in claim 9, further comprising another retaining block, wherein the retaining block is slidably mounted to the body section and disposed between the coil spring and the other end of the elastic sheet.

11. The sliding mechanism as claimed in claim 9, wherein the retaining block defines a V-shaped groove receiving one end of the elastic sheet.

12. The sliding mechanism as claimed in claim 8, wherein the cover section includes a plate and two securing columns, the plate including a top surface and a bottom surface, from a center of which the securing columns closely protrude, forming a securing space therebetween fixing the elastic sheet.

13. A sliding mechanism, comprising:
a body section;
a cover section;
an elastic sheet fixed to the cover section; and
a retaining block being slidably to the body section, the retaining block being used to deform the elastic sheet to generate tensile force, driving the cover section to slide relative to the body section.

14. The sliding mechanism as claimed in claim 13, further comprising a coil spring, wherein the coil spring mounted to the body section, the retaining block is disposed between the coil spring and one end of the elastic sheet.

15. The sliding mechanism as claimed in claim 14, further comprising another retaining block, wherein the retaining block is slidably mounted to the body section and disposed between the coil spring and the other end of the elastic sheet.

16. The sliding mechanism as claimed in claim 13, wherein the retaining block defines a V-shaped groove receiving one end of the elastic sheet.

17. The sliding mechanism as claimed in claim 13, wherein the cover section includes a plate and two securing columns, the plate including a top surface and a bottom surface, from a center of which the securing columns closely protrude, forming a securing space therebetween fixing the elastic sheet.
